(19) United States
(12) Patent Application Publication
(10) Pub. No.: US 2004/0066017 A1
(43) Pub. Date: Apr. 8, 2004

(54) Bicycle drive train

(76) Inventor: George J. Dratewski, Wheeling, IL (US)

Correspondence Address: ROGER A JACKSON, ESQ, 16430 WEST ELLSWORTH AVENUE, GOLDEN, CO, 80401-6545, US

(21) Appl. No.: 10/065,335

(22) Filed: Oct. 4, 2002

(51) Int. Cl. B62M 1/02

(52) U.S. Cl. 280/260

(57) ABSTRACT

A drive train for a bicycle includes a housing mounted in a bicycle frame with a pedal assembly attached to a drive shaft fixably mounting a plurality of different diameter drive elements, the drive shaft is journalled in and between the housing cover plates. A driven shaft is also journalled in and between the housing cover plates. The driven shaft mounts a plurality of rotatably unfixed different diameter driven elements, with the driven shaft rotationally coupled to a bicycle rear wheel. A plurality of connection elements rotationally couples the plurality of different diameter drive elements to the different diameter driven elements, wherein a single connection element rotatably couples a single drive element to a single driven element that are in alignment. Also, a means for rotatably engaging a selected single driven element to the driven shaft to establish a selected rotational ratio between the drive shaft and the driven shaft.

### TECHNICAL FIELD

The present invention relates to a mechanical drive for a bicycle, in particular, to a gear speed change apparatus for transferring rotational motion from the pedals to the rear wheel of the bicycle.

### BACKGROUND OF INVENTION

Conventional bicycles utilize a sprocket and chain drive apparatus. The reasons for a sprocket and chain drive apparatus are many in a bicycle, primarily being related to minimizing the space, weight, and frictional drive train resistance that are desirable qualities of a bicycle drive apparatus. This is as compared to a conventional variable ratio gear transmission that would typically include a plurality of gears, which are selectively inner meshed to provide variable speed transformation through changing gear ratios. However, this conventional type of gear transmission tends to be large, heavy, having high frictional losses, and is mechanically complex which are undesirable attributes for a bicycle drive train apparatus.

The conventional bicycle drive train apparatus generally includes two shift levers or grip shifts connected to front and rear derailleur mechanisms. The major drawbacks of the aforementioned sprocket and chain drive apparatus are that changing gears requires the use of two controls (grip shifts or levers), one for the front sprocket set and one for the rear derailleur sprocket set. In many instances, changing gears or speeds is not a smooth operation due to the chain jumping up and down across the multiple sprockets. The chain can even jump completely off of the sprocket if not operated carefully and smoothly enough. Also, selecting a speed is confusing because not everyone understands that although twenty-one speeds are typically theoretically possible, not all combinations of the front and rear sprockets are practical to use. A typical bicycle has three front sprockets and seven rear sprockets, theoretically providing twenty-one gears if all combinations of front and rear sprockets are used. In reality, each front sprocket only provides a useable gear combination with three to four of the positions of the rear sprocket, resulting in nine to twelve usable gears. Combinations of the extreme angular position of front and rear sprocket alignment forces the chain to work in an undesirable diagonal or angular position. The chain is not designed to work in this illogical position or gear combination as chains have very little sideways flexibility with the chain possibly seeking to switch itself to the more logical position thus minimizing the chain's sideways angularity.

Additionally, the chain itself presents many inherent problems. Its oil attracts dust and spreads oil on to the bicycle frame and occasionally on to the legs of the bicycle rider. If the chain is dry, in other words devoid of oil, it will not operate properly and will be prone to making noise, and experiencing excessive wear including a high degree of frictional resistance while in use by the bicycle rider. Another problem is in replacing the chain, which cannot be removed from the bicycle without the use of special tools or to actually break the chain. Plus, derailleurs suffer from their complexity. They are delicate, difficult to adjust, and are easy to bend or be damaged. This is especially true for the rear derailleur, which may protrude very low on the bicycle, and other words being close to the riding surface or ground. Once it is bent, it is very difficult to adjust or repair. Another issue is in, attaching and removing the rear wheel, which is both complicated and dirty. A lot of work can and quite a bit of knowledge are required to do it correctly, and it is nearly impossible to do without getting substantial amounts of grease on one's hands. Finally, it is problematic for the rider to change gears effectively enough to go from level pavement to a hill or from a very fast speed to a slower speed. On the conventional prior art bicycle drive train apparatus the rider must change both the front and rear years, going through every gear in between. Thus, it is impossible to switch directly and smoothly from fast to slow without going through the gears in between.

Prior art solutions to the aforementioned problems are disclosed in U.S. Pat. No. 4,697,469 to Takamiya et al. and U.S. Pat. No. 5,971,877 to Hunter, Jr. et al. that attempt to solve the issues of multiple sprocket derailleurs by using an enclosed assembly of a plurality of pawls that engaged to a driving internally toothed ratchet on the outermost extremity of the pawl, with the pawl attached to a driven rotary body on the innermost extremity of the pawl. A variable gear ratio between the driving and driven elements is achieved by the driven rotary body having an adjustable eccentric positional relationship with the driving internally toothed ratchet. This causes the engagement between the internally toothed ratchet and the outermost extremity of the pawl to only occur through a limited angular segment of the circumference of rotation, sometimes called the driving zone of which is approximately 60 degrees. Although, Takamiya et al. and Hunter, Jr. et al. do manage to dispose of multiple sprockets, chain angularity, and shifting problems, the pawl eccentric arrangement does have its own limitations and problems with a limited gear ratio differential, in other words the change in minimum to maximum gear ratio is limited due to the mechanical positioning of the pawl length and angularity in relation to the amount of eccentric position between the driving and driven elements. In addition, under heavy or high load use the pawls outmost extremities can wear where they engage with the internally toothed ratchet causing slippage between the driving and driven elements.

Another series of prior art solutions to the aforementioned problems, although not specifically designed for bicycle drive train applications are given and U.S. Pat. No. 6,146,296 to Apostolo, U.S. Pat. No. 5,871,41 2 to Moser, and U.S. Pat. No. 4,1 58,31 6 to Strong, wherein these three identified prior art patents utilize a series of different size pulleys or sprockets that are co-axially located and fixed on a first common shaft that are parallel to another series of different sized pulleys or sprockets not affixed to a second common shaft that have an inverse relationship in that a large diameter pulley sprocket is aligned with a small diameter pulley sprocket wherein the aligned set of pulleys or sprockets are connected by a belt a chain respectively. Different drive gear ratios are achieved by the interface between the second common shaft and its associated pulleys or sprockets being selectively rotationally engaged on an individual pulley or sprocket basis, thus allowing only one set of pulleys or sprockets to actually transmit rotational power between the first common shaft and second common and shaft at any one time. Again, this type of system eliminates the previously mentioned chain angularity problem, however, there is a drawback of the added complexity of the selective engagement system between an individual pulley or sprocket and shaft, also sometimes the size or space requirements of this type of variable ratio drive system are undesirable.

What is needed is a bicycle drive train apparatus that is light in weight, smaller in size, has low frictional resistance, and not having any the aforementioned to problems that exist in the prior art. This would dictate that a chain and sprocket system be used to effectuate high efficiency or low loss power transmission on a bicycle, however, without imparting any angularity into the chain alignment thus requiring that the drive sprockets remain in alignment during use, while it the same time achieving a wide range of different gear ratios.

### SUMMARY OF INVENTION

The present invention of a drive train for bicycles includes a housing assembly that is mounted at a lower middle junction of the bicycle frame, which has a pedal assembly journalled therein. The pedal assembly includes a drive shaft that fixably mounts a plurality of different diameter drive elements coaxially. The drive shaft has a drive shaft rotational axis and is journalled in and between a housing first end cover plate and a housing second end cover plate of the housing assembly. The drive elements have a generally conical envelope extending between the housing first end cover plate and the housing second end cover plate of the housing assembly. Also included, is a driven shaft that is journalled in and between the housing first end cover plate and the housing second end cover plate of the housing assembly. The driven shaft has a driven shaft rotational axis positioned parallel to the drive shaft rotational axis. The driven shaft mounts a plurality of rotatably unfixed different diameter driven elements coaxially. The driven elements have a generally conical envelope extending between the housing first end cover plate and the housing second end cover plate of the housing assembly, with the driven shaft rotationally coupled to a bicycle rear wheel.

In addition, the drive train for bicycles includes a plurality of connection elements for rotationally coupling the plurality of different diameter drive elements to the different diameter driven elements such that a single connection element rotatably couples a single drive element to a single driven element that are in alignment. Also, a means for rotatably engaging a selected single driven element to the driven shaft is operational to establish a selected rotational ratio between the drive shaft and the driven shaft.

These and other objects of the present invention will become more readily appreciated and understood from a consideration of the following detailed description of the exemplary embodiments of the present invention when taken together with the accompanying drawings, in which;

### BRIEF DESCRIPTION OF DRAWINGS

FIG. 1 is a perspective view of the bicycle drive train assembly in its entire housing;

FIG. 2 is a perspective view of the bicycle drive train assembly with a central body shell of the housing removed;

FIG. 3 is a perspective view of the bicycle drive train assembly with the entire housing assembly removed that includes the central body shell and a first end cover plate and a second end cover plate;

FIG. 4 shows a central body view of the sprocket alignment between the drive shaft and the driven shaft;

FIG. 5 shows a crossectional side view of the driven shaft and sprockets in the housing assembly;

FIG. 6 shows a crossectional view of the driven shaft with an axially slidable body;

FIG. 7 shows a crossectional view of the driven shaft with the axially slidable body including a finger and a spring, with a plurality of driven shaft apertures;

FIG. 8 shows a perspective view of the axially slidable body with a plurality of fingers and springs;

FIG. 9 shows a side view of the axially slidable body with a plurality of fingers and springs;

FIG. 10 shows a crossectional view of the axially slidable body;

FIG. 11 shows a side view of the axially slidable body with a plurality of fingers and springs;

FIG. 12 shows a crossectional view of the axially slidable body with the plurality of fingers and springs;

FIG. 13 shows a perspective view of a portion of the driven shaft assembly with the axially slidable body, the driven shaft, and the plurality of different diameter driven elements;

FIG. 14 shows an end view of the driven shaft with the single driven sprocket;

FIG. 15 shows a crossectional view of the driven shaft with the axially slidable body rotationally engaged to the single driven sprocket, thus affixing the sprocket and the driven shaft;

FIG. 16 shows a perspective view of the handlebar mounted selector for bicycle rider selected drive train transmission ratios; and

FIG. 17 shows a side elevation of a bicycle incorporating the present invention of the bicycle drive train.

### REFERENCE NUMBER IN DRAWINGS

20 Bicycle drive train assembly

22 Housing assembly

24 Drive shaft rotational axis

25 Drive shaft

26 Driven shaft rotational axis

27 Driven shaft

28 Housing central body shell

29 Driven shaft outside diameter

30 Housing first end cover plate

32 Housing second end cover plate

34 Drive shaft rotational direction

36 Driven shaft rotational direction

38 Plurality of different diameter drive elements

39 Single drive element

40 Plurality of different diameter driven elements

41 Selected single driven element

42 Plurality of connection elements

43 Single connection element

44 Drive toothed wheel

45 Driven toothed wheel

46 Direct acting control cable

47 Spring support

48 Reverse acting control cable

49 Spring shoe

50 Axially slidable body

51 Body axial movement

52 Driven shaft apertures

53 Void in driven shaft

54 Finger

55 Single driven shaft aperture

56 Spring

57 Driven element cavities

58 Handlebar assembly

59 Single driven element cavity

60 Handlebar mounted selector

61 Internal diameter of driven elements

62 Handle rotation

64 Bicycle

66 Bicycle frame

68 Bicycle front wheel

70 Bicycle rear wheel

72 Bicycle seat

74 Lower middle junction of bicycle frame

76 Bicycle pedal assembly

78 Bicycle pedal

80 Final drive belt or chain

### DETAILED DESCRIPTION

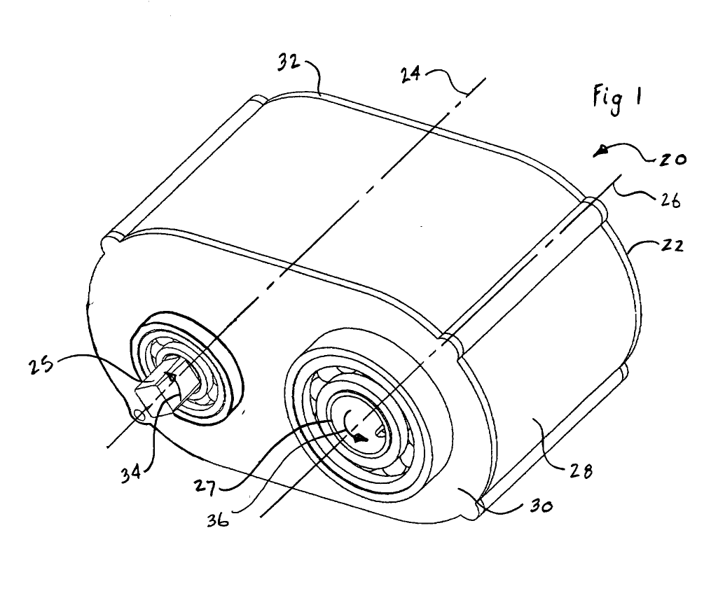

With initial reference to FIG. 1 shown is a perspective view of the complete bicycle drive train assembly 20. A drive shaft rotational axis 24 and a driven shaft rotational axis 26 are shown to be positioned parallel to one another. A drive shaft 25 rotates about the drive shaft rotational axis 24 in a drive shaft rotational direction 34 being coincident with a driven shaft 27 that rotates about the driven shaft rotational axis 26 in a driven shaft rotational direction 36. Also shown is the housing assembly 22 that comprises a housing central body shell 28 and a housing first end cover plate 30 and a housing second end cover plate 32. The drive shaft 25 is journalled in and between the housing first end cover plate 30 and the housing second end cover plate 32 of the housing assembly 22. Likewise, the driven shaft 27 is journalled in and between the housing first end cover plate 30 and the housing second end cover plate 32 of the housing assembly 22. It is preferred that the drive shaft 25 and the driven shaft 27 that are both journalled in and between the housing first end cover plate 30 and the housing second end cover plate 32 be rotationally mounted as shown with the use of conventional ball bearings. However, other types of bearings would also be acceptable, such as roller bearings, sleeve bearings, or any other type of bearing that would meet the conditions required for operation of the bicycle drive train assembly 20.

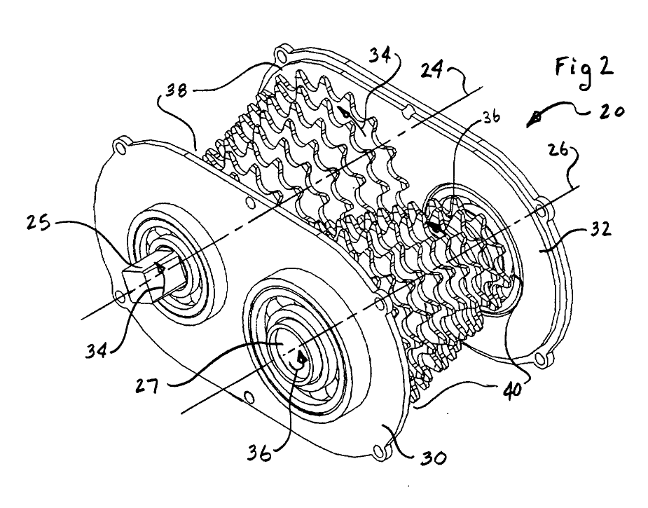

Moving next to FIG. 2 shown is a perspective view of the bicycle drive train assembly 20 as shown in FIG. 1 with the central body shell 28 of the housing assembly 22 removed to show a plurality of different diameter drive elements 38 and a plurality of different diameter driven elements 40. As described in FIG. 1 the drive shaft rotational axis 24 and the driven shaft rotational axis 26 are shown to be positioned parallel to one another. The drive shaft 25 rotates about the drive shaft rotational axis 24 in the drive shaft rotational direction 34 being coincident with the driven shaft 27 that rotates about the driven shaft rotational axis 26 in the driven shaft rotational direction 36. Also shown is a portion of the housing assembly 22 with the housing first end cover plate 30 and the housing second end cover plate 32. The drive shaft 25 is journalled in and between the housing first end cover plate 30 and the housing second end cover plate 32 of the housing assembly 22. Likewise, the driven shaft 27 is journalled in and between the housing first end cover plate 30 and the housing second end cover plate 32. It can also be seen that both the plurality of different diameter drive elements 38 and the plurality of different diameter driven elements 40 have a generally conical envelope that extends between the housing first end cover plate 30 and the housing second in cover plate 32.

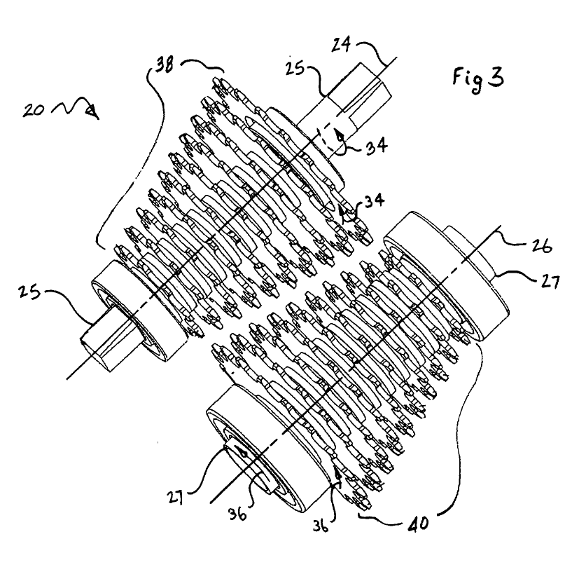

Further, to FIG. 3 shown is a perspective view of the bicycle drive train assembly 20 with the entire housing assembly 22 removed. Paying particular attention to the drive shaft 25 there are fixably mounted a plurality of different diameter drive elements 38 that are co-axially positioned about the drive shaft rotational axis 24, also indicated is the drive shaft rotational direction 34. Again, likewise the driven shaft 27 mounts a plurality of rotatably unfixed different diameter driven elements 40 that are co-axially positioned about the driven shaft rotational axis 26, also indicated is the driven shaft rotational direction 36.

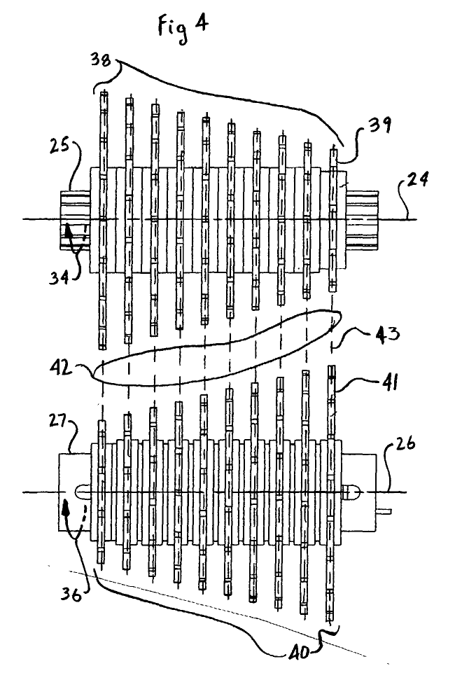

Next, to FIG. 4 shown is a central body view of the alignment between the plurality of different diameter drive elements 38 and the plurality of different diameter driven elements 40 respectively mounted upon the drive shaft 25 and the driven shaft 27 with the attendant drive shaft rotational axis 24 and drive shaft rotational direction 34 and the driven shaft rotational axis 26 and the driven shaft rotational direction 36 as previously described. The alignment between the plurality of different diameter drive elements 38 and the plurality of different diameter driven elements 40 is shown with a plurality of connection elements 42 there used for rotationally coupling the plurality of different diameter drive elements 38 to the plurality of different diameter driven elements 40. Thus, the plurality of connection elements 42 is such that a single connection element 43 rotatably couples a single drive element 39 to a single driven element 41 that are in alignment to enable the transfer of rotational motion from the plurality of different diameter drive elements 38 to the plurality of different diameter and driven elements 40. Preferably, the plurality of different diameter drive elements 38 are constructed of chain sprockets as well as the plurality of different diameter driven elements 40 also being constructed of chain sprockets. In accordance with this, the plurality of connection elements 42 would preferably be constructed of a plurality of chain drive loops 42 rotationally coupling the plurality of different diameter drive chain sprockets 38 to the plurality of different diameter driven chain sprockets 40. Again, the plurality of connection elements 42 that would be constructed of a plurality of chain drive loops is such that a single chain drive loop 43 rotatably couples a single drive chain sprocket 39 to a single driven chain sprocket 41 that are in alignment to enable the transfer of rotational motion from the plurality of different diameter drive chain sprockets 38 to the plurality of different diameter and driven chain sprockets 40. Alternatively, the plurality of connection elements 42 could be belts or toothed belts that would matingly engage the plurality of different diameter drive elements 38 to the plurality of different diameter and driven elements 40 with the plurality of different diameter drive elements 38 and the plurality of different diameter and driven elements 40 accommodating the aforementioned belts.

The following is a comparison of the prior art bicycle drive train ratio versus the present invention drive train ratio.

The total gear ratio of a typical prior art mountain bike can be calculated as follows;

Rear sprocket-smallest-11 teeth

Rear sprocket-biggest-28 teeth

Front sprocket-smallest-24 teeth

Front sprocket-biggest-38 teeth

Fast driving ratio=38/11=3.450

Slow driving ratio=24/28=0.857

Total ratio=3.450/0.857=4

Referring to the present invention as an example, the plurality, 10 for example, different diameter drive chain sprockets 38 and the plurality, again 10 for example, of different diameter driven chain sprockets 40, that would result in a 10 speed gearbox, the largest single drive or driven element is twice the diameter of the smallest single drive or driven element. In this case, the overall gear ratio on the present invention can be calculated as follows;

Fast driving ratio=2/1=2

Slow driving ratio=1/2=0.5

Total ratio=2/0.5=4

Thus, the total gear ratio of the present invention is equal to the total gear ratio of a typical prior art mountain bike, however, any number of deviations for the total ratio and/or number of drive and driven elements of the present invention are possible depending upon the bicycle rider, the bicycle type, and the terrain ridden upon.

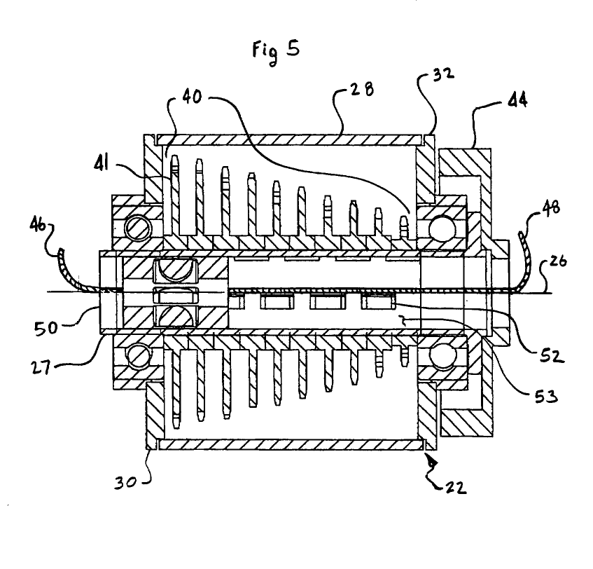

Looking next to FIG. 5 shown is a cross sectional side view of the driven shaft 27 and the drive shaft rotational axis 26 in the housing assembly 22 that includes in this view the housing central body shell 28, the housing first end cover plate 30, and the housing second end cover plate 32. Also shown is the plurality of different diameter driven elements 40 mounted in a rotatably unfixed manner to the driven shaft 27. Also shown is a drive toothed wheel 44 that is fixedly attached to the driven shaft 27, wherein the drive toothed wheel 44 allows the driven shaft 27 to be rotationally coupled to a bicycle rear wheel. A means for rotatably engaging 50 a selected single driven element 41 to the driven shaft 27 whose purpose is to establish a selected rotational ratio between the drive shaft 25 (not shown) and the driven shaft 27. When the selected single driven element 41 is rotationally engaged to the driven shaft 27, the remaining plurality of different diameter driven elements 40 are rotationally unfixed to the driven shaft 27, thus at any one time only a single one selected single driven element 41 is rotationally engaged to the driven shaft 27.

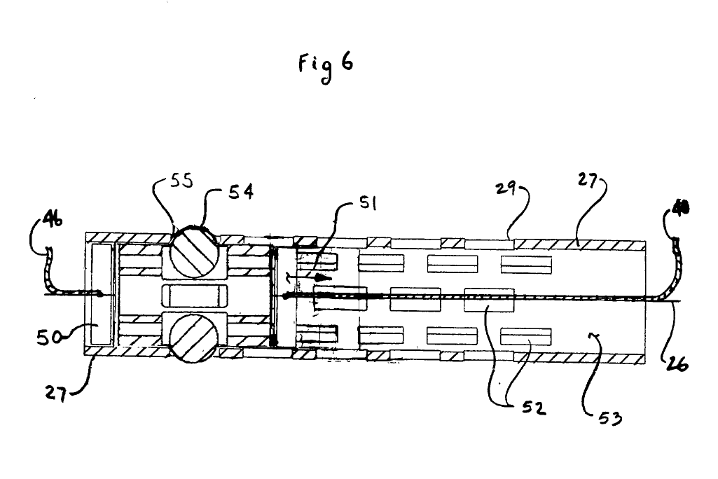

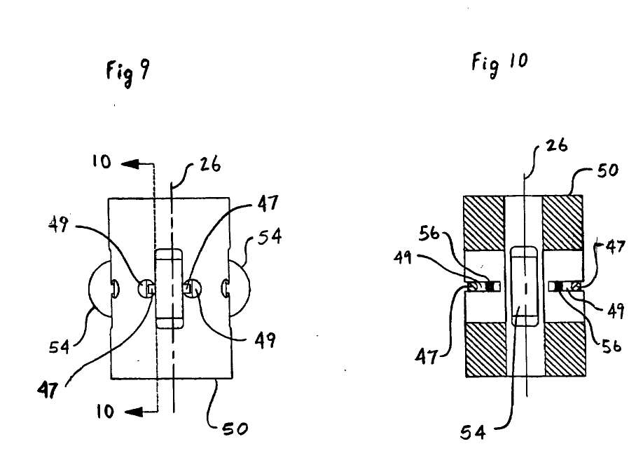

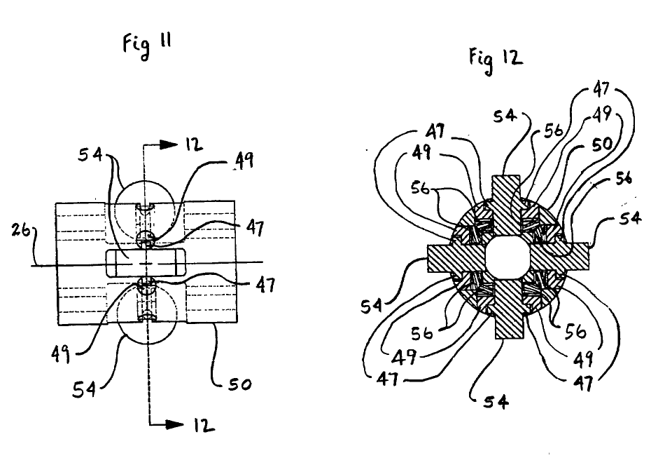

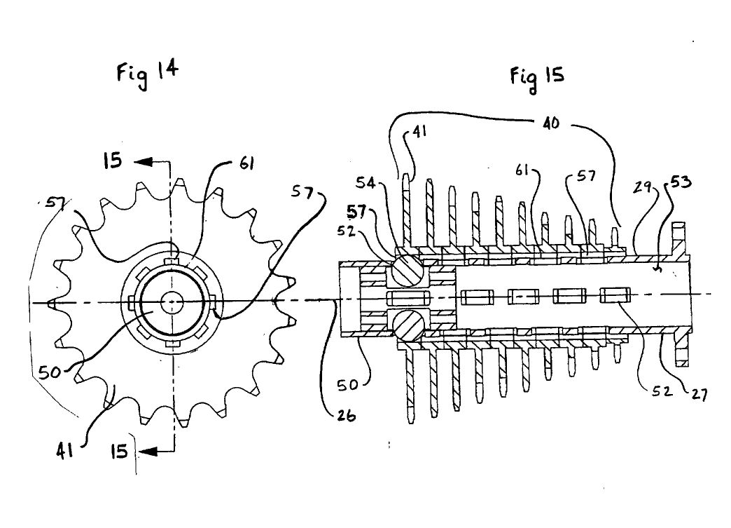

The means for rotatably engaging a selected single driven element 41 to the driven shaft 27 preferably comprises an axially slidable body 50 that is in a void 53 that is within the driven shaft 27, with the body 50 being axially movable to a selected axial position along the driven shaft rotational axis 26. When the body 50 is at the selected axial position, the body 50 will act to rotationally engage the selected single driven element 41 to establish the selected rotational ratio between the drive shaft 25 (not shown) and the driven shaft 27. The body 50 utilizes a plurality of driven shaft apertures 52 for rotationally engaging the selected single driven element 41 and the driven shaft 27, with more detail given on the plurality of driven shaft apertures 52 in FIGS. 6 through 14. Returning to FIG. 5 the selected axial position of the body 50 is accomplished by an axial linkage that is within the void 53, with the axial linkage being adjacent to the body 50 and extending through the void 53 and outward beyond the driven shaft 27. The axial linkage is can be comprised of a direct acting control cable 46 alone that is adjacent to the body 50 with preferably a rotatable couple arrangement to allow the body 50 to rotate with the driven shaft 27 while the direct acting control cable 46 is able to exert axial force upon the body 50. Thus, the direct acting control cable 46 achieves the selected axial position of the body 50 in the void 53 of the driven shaft 27 by the direct acting control cable 46 being connected to a handle bar mounted selector 60 of the bicycle 64 (not shown). If the direct acting control cable 46 is used alone then a means for urging the body 50 a selected axial position in the void 53 in a direction opposite of what the direct acting control cable 46 would move the body 50 to along the driven shaft rotational axis 26 would be utilized in the form of a spring.

Preferably, the axial linkage would comprise both the direct acting control cable 46 and a reverse acting control cable 48 that is also adjacent to the body 50 with a rotational couple that would be used, wherein the reverse acting control cable 48 would be operable to move the body 50 in an opposite axial direction from what the direct acting control cable 46 is capable of. Thus, with the use of both the direct acting control cable 46 and the reverse acting control cable 48 to axially pull or urge the body 50 axially bidirectionally within the void 53 to the selected axial position. Both the direct acting control cable 46 and the reverse acting control cable 48 would be connected to a handle bar mounted selector 60 of the bicycle 64 (not shown). In either case, using the direct acting control cable 46 alone or the combination of the direct acting control cable 46 and the reverse acting control cable 48, movement of the handlebar mounted selector 60 of the bicycle 64 (not shown) would result in axial movement of the body 50 within the void 53 to the selected axial position resulting in the rotational engagement of the selected single driven element 41 with the driven shaft 27 with the ultimate result being a selected rotational ratio between the drive shaft 25 (not shown) and the driven shaft 27.

Further looking to FIGS. 6, 7, 8, 9,10, 11, 12, 13, and 14 additional detail is given on the body 50, the driven shaft 27, and the selected single driven element 41 structural and operational interface. Initially referring to FIG. 6 shown is the driven shaft 27 with the driven shaft rotational axis 26 having a plurality of apertures 52 that essentially go through the driven shaft 27 wall going from the void 53 to an outside diameter 29 of the driven shaft 27. The direct acting control cable 46 and the reverse acting control cable 48 are shown and operate as previously described to effectuate selected body axial movement 51. Also shown is a finger 54 that is biased to insert through a single aperture 55 of the driven shaft 27 allowing the finger 54 to project beyond the outside diameter 29 of the driven shaft 27. The biasing of the finger 54 is preferably accomplished by the use of a spring 56 (not shown). Alternatively, the biasing of the finger 54 could be accomplished by the use of magnets, or other mechanical equivalents that would bias the finger 54 to insert through the single aperture 55 resulting in the FIG. 54 protruding beyond the driven shaft outside diameter 29.

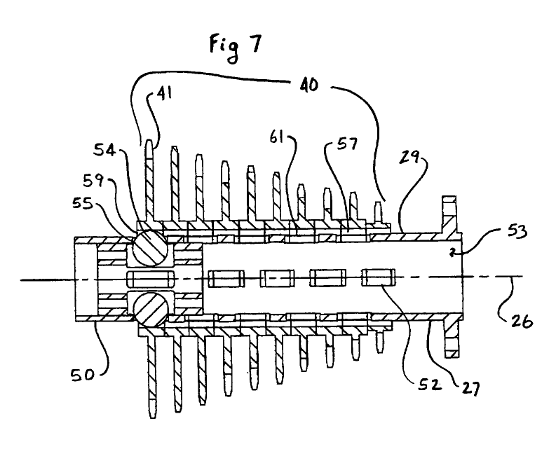

Further, looking to FIG. 7 which adds the plurality of different diameter driven elements 40 to the driven shaft 27, with the driven shaft rotational axis 26 as shown in FIG. 6. Again, is shown the driven shaft 27 with the driven shaft rotational axis 26 having a plurality of apertures 52 that essentially go through the driven shaft 27 wall going from the void 53 to an outside diameter 29 of the driven shaft 27. Looking to the plurality of different diameter driven elements 40 a plurality of driven element cavities 57 are located on an internal diameter 61 of the plurality of driven elements 40. More particularly, the selected single driven element 41 has a cavity 59 that is aligned with one of the apertures 55 that is facilitated by the relative rotational movement between the driven shaft 27 and the selected single driven element 41. It can be seen that the finger 54 of the body 50 inserts through the single aperture 55 and is received into the single cavity 59 of the selected single driven element 41, as biased by the spring 56 (not shown), thus facilitating the rotational engagement of the selected single driven element 41 with the driven shaft 27. This requires at least one aperture 55 to be in alignment with at least a single cavity 59 thereby allowing the finger 54 to insert through the single aperture 55 and be received into the single cavity 59. This results in the rotational engagement of the single selected driven element 41 to the driven shaft 27.

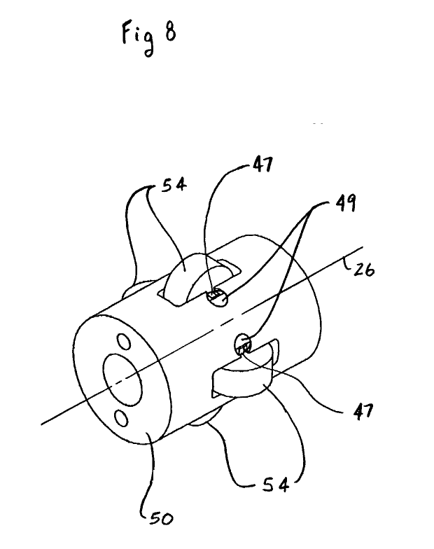

Next, referring to FIG. 8 shown is a perspective view of the body 50 with a plurality of fingers 54 being in the biased position from the plurality of springs 56 (not shown) that work in conjunction with a plurality of spring shoes 49, and a plurality of spring supports 47, with the driven shaft rotational axis 26 shown for reference. The body 50 can be operational as previously described with a single finger 54. However, it is preferred to utilize the body 50 with the driven shaft rotational axis 26 shown for reference as it is shown in FIGS. 8, 9,10, 11, and 12 utilizing a plurality of fingers 54 and their associated plurality of biasing springs 56 also working in conjunction with the plurality of spring shoes 49, and the plurality of spring supports 47. The plurality of fingers 54 facilitates a more rapid engagement of the selected single driven element 41 (not shown) and the driven shaft 27 (not shown). Thus, a plurality of fingers 54 seeking to be received into a plurality of driven element cavities 57 (not shown) allows for this more rapid engagement of the selected single driven element 41 (not shown) and the driven shaft 27 (not shown) as previously described. This is as compared to a single finger 54 seeking to be received by a single cavity 59 (not shown) which could conceivably allow almost a full rotation of the selected single driven element 41 (not shown) prior to engagement to the driven shaft 27 (not shown). In addition, a plurality of fingers 54 will allow for a higher torque transmission between a selected single driven element 41 (not shown) and the driven shaft 27 (not shown).

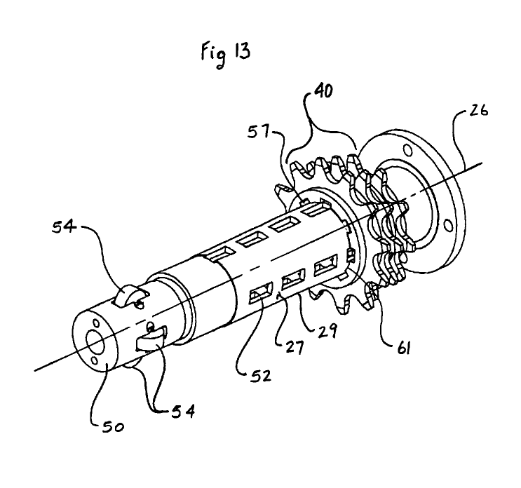

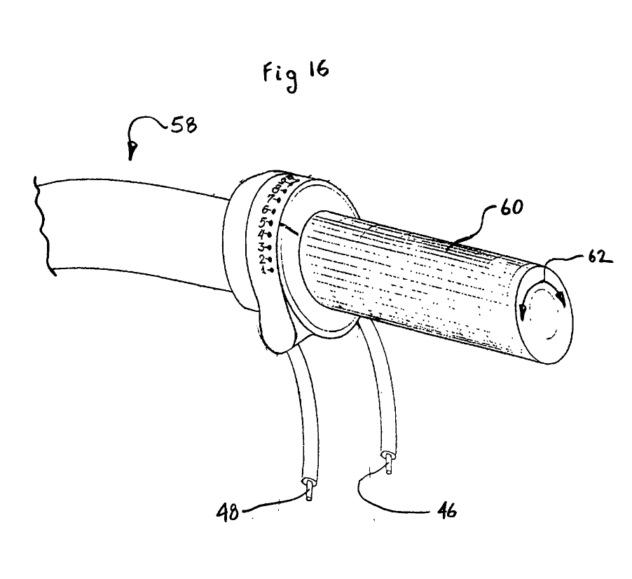

Moving next to FIGS. 13, 14, and 15 shown are perspective, end, and crossectional views respectively of the driven shaft 27 with the driven shaft rotational axis 26 with the plurality of different diameter driven elements, and the selected single driven element 41 having the body 50 rotationally engaging the selected single driven element 41 and the driven shaft 27. The plurality of apertures 52 that essentially go through the driven shaft 27 wall going from the void 53 to an outside diameter 29 of the driven shaft 27. Also shown is the plurality of fingers 54 that are biased by the spring 56 (not shown) to insert through the plurality of apertures 52 of the driven shaft 27 allowing the fingers 54 to project beyond the outside diameter 29 of the driven shaft 27. More particularly, the selected single driven element 41 has a plurality of cavities 57 being located on the internal diameter 61 of the selected driven element 41, with the plurality of cavities 57 being aligned with a portion of the plurality of apertures 52 that is facilitated by the relative rotational movement between the driven shaft 27 and the selected single driven element 41. It can be seen that the fingers 54 of the body 50 insert through the apertures 52 and are received into the plurality of cavities 57 of the selected single driven element 41, as biased by the spring 56 (not shown), thus facilitating the rotational engagement of the selected single driven element 41 with the driven shaft 27.

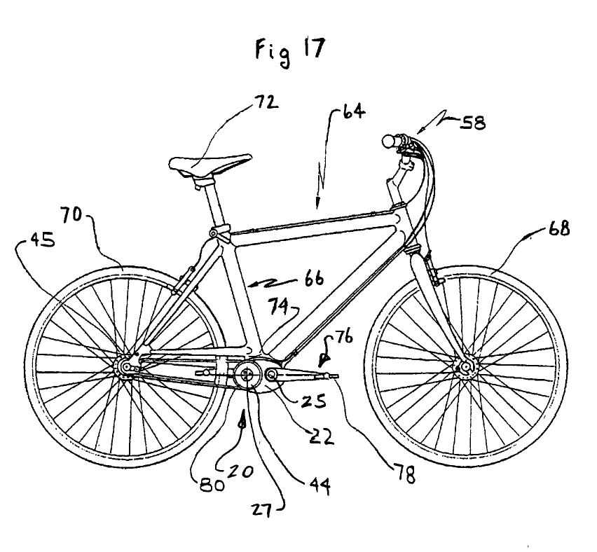

Next, looking to FIG. 16 shown is a perspective view of a handlebar assembly 58 mounted selector 60 that is attached to the direct acting control cable 46 and the reverse acting control cable 48. The bicycle rider rotationally moves the selector 60 through the rotational motion as denoted by a handle rotation 62 to push and pull the aforementioned cables that are rotationally coupled to the body 50 (not shown) to selectively achieve the desired rotational ratio between the drive shaft 25 (not shown) and the driven shaft 27 (not shown). Alternatively, if the direct acting control cable 46 is used alone in the selector 60 would only act to pull the direct acting control cable 46 with the cable being able to retract in the opposite direction through the means for urging the body 50 (not shown) as previously described.

Finally, FIG. 17 shows a side elevation of a bicycle 64 including a bicycle frame 66, a front wheel 68, a rear wheel 70, a seat 72, and the handlebar assembly 58. The bicycle 64 incorporates the present invention of the bicycle drive train assembly 20 that is mounted at a lower middle junction 74 of the bicycle frame 66. A bicycle pedal assembly 76 including bicycle pedals 78 is affixed to the drive shaft 25 wherein the pedal assembly 76 is journalled therein with respect to the housing assembly 22. The driven shaft 27 of the bicycle drive train assembly 20 has the drive toothed wheel 44 that is rotationally attached to the driven shaft 27. The drive toothed wheel 44 is rotationally coupled to the bicycle rear wheel 70 through the use of a final drive belt 80 and driven toothed wheel 45. The driven toothed wheel 45 is attached to the bicycle rear wheel 70 through a conventional one way clutch also known as a free wheel to allow free backpedaling as in a conventional bicycle. Alternatively, the final drive belt 80 could be a conventional bicycle chain with the drive toothed wheel 44 becoming a drive chain sprocket and the driven toothed wheel 45 becoming a driven chain sprocket. In addition, further extension of the overall rotational ratio between the bicycle pedals assembly 76 and the bicycle rear wheel 70 can be accomplished by changing the diameters of the drive toothed wheel 44 and the driven toothed wheel 45 to accommodate a different bicycle rider, bicycle, or terrain. This, for example, would be to transfer or convert the bicycle from a mountain bike to a road bike and vice versa.

### CONCLUSION

Accordingly, the present invention of a bicycle drive train has been described with some degree of particularity directed to the embodiments of the present invention. It should be appreciated, though, that the present invention is defined by the following claims construed in light of the prior art so modifications the changes may be made to the exemplary embodiments of the present invention without departing from the inventive concepts contained therein.

1. A drive train for a bicycle, comprising:
(a) a housing assembly mounted at a lower middle junction of a bicycle frame, which has a pedal assembly journalled therein;
(b) a drive shaft fixably mounting a plurality of different diameter drive elements coaxially, said drive shaft having a drive shaft rotational axis and being journalled in and between a housing first end cover plate and a housing second end cover plate of said housing assembly, the pedal assembly rotationally coupled to said drive shaft, said drive elements having a generally conical envelope extending between said first end cover plate and said second end cover plate;
(c) a driven shaft journalled in and between said first end cover plate and said second end cover plate, said driven shaft having a driven shaft rotational axis positioned parallel to said drive shaft rotational axis, said driven shaft mounting a plurality of rotatably unfixed different diameter driven elements coaxially, said driven elements having a generally conical envelope extending between said first end cover plate and said second end cover plate, said driven shaft rotationally coupled to a bicycle rear wheel;
(d) a plurality of connection elements for rotationally coupling said plurality of different diameter drive elements to said plurality of different diameter driven elements such that a single connection element rotatably couples a single drive element to a single driven element that are in alignment; and
(e) a means for rotatably engaging a selected single driven element to said driven shaft to establish a selected rotational ratio between said drive shaft and said driven shaft.

2. A drive train for a bicycle according to claim 1 wherein said means for rotatably engaging is an axially slidable body in a void within said driven shaft movable to a selected axial position along said driven shaft rotational axis corresponding to engaging said selected single driven element, said selected axial position is accomplished by an axial linkage within said void that is adjacent to said body and extends beyond said driven shaft.

3. A drive train for a bicycle according to claim 2 wherein said driven shaft has a plurality of apertures between said void and an outside diameter of said driven shaft.

4. A drive train for a bicycle according to claim 3 wherein said plurality of different diameter driven elements have a plurality of cavities located on an internal diameter of said plurality of different diameter driven elements such that at least one of said cavities align with at least one of said apertures when there is relative rotational movement between said driven shaft and said plurality of different diameter driven elements.

5. A drive train for a bicycle according to claim 4 wherein said body further comprises a finger that is biased to insert through an aperture of said driven shaft with said finger being received into a cavity of said selected single driven element for engaging said selected single driven element to said driven shaft when said aperture and said cavity are in alignment.

6. A drive train for a bicycle according to claim 5 wherein said finger is biased by a spring.

7. A drive train for a bicycle according to claim 5 wherein said body further comprises a plurality of fingers.

8. A drive train for a bicycle according to claim 7 wherein said plurality of fingers are biased by a plurality of springs.

9. A drive train for a bicycle according to claim 2 wherein said axial linkage is a direct acting control cable attached to a handlebar mounted selector on the bicycle wherein movement of said handlebar selector moves said direct acting cable resulting in axial movement of said body within said void.

10. A drive train for a bicycle according to claim 9 wherein said axial linkage further comprises a reverse acting control cable that is operable to move in an opposite direction from said direct acting control cable to axially pull said body axially bidirectionally within said void.

11. A drive train for a bicycle, comprising:
(a) a housing assembly mounted at a lower middle junction of a bicycle frame, which has a pedal assembly journalled therein;
(b) a drive shaft fixably mounting a plurality of different diameter drive chain sprockets coaxially, said drive shaft having a drive shaft rotational axis and being journalled in and between a housing first end cover plate and a housing second end cover plate of said housing assembly, the pedal assembly rotationally coupled to said drive shaft, said drive chain sprockets having a generally conical envelope extending between said first end cover plate and said second end cover plate;
(c) a driven shaft journalled in and between said first end cover plate and said second end cover plate, said driven shaft having a driven shaft rotational axis positioned parallel to said drive shaft rotational axis, said driven shaft mounting a plurality of rotatably unfixed different diameter driven chain sprockets coaxially, said driven chain sprockets having a generally conical envelope extending between said first end cover plate and said second end cover plate, said driven shaft rotationally coupled to a bicycle rear wheel;
(d) a plurality of chain drive loops for rotationally coupling said plurality of different diameter drive chain sprockets to said plurality of different diameter driven chain sprockets such that a single chain drive loop rotatably couples a single drive chain sprocket to a single driven chain sprocket that are in alignment; and
(e) a means for rotatably engaging a selected single driven chain sprocket to said driven shaft to establish a selected rotational ratio between said drive shaft and said driven shaft.

12. A drive train for a bicycle according to claim 11 wherein said means for rotatably engaging is an axially slidable body in a void within said driven shaft movable to a selected axial position along said driven shaft rotational axis corresponding to engaging said selected single driven chain sprocket, said selected axial position is accomplished by an axial linkage within said void that is adjacent to said body and extends beyond said driven shaft.

13. A drive train for a bicycle according to claim 12 wherein said driven shaft has a plurality of apertures between said void and an outside diameter of said driven shaft.

14. A drive train for a bicycle according to claim 13 wherein said plurality of different diameter driven chain sprockets have a plurality of cavities located on an internal diameter of said plurality of different diameter driven chain sprockets such that at least one of said cavities align with at least one of said apertures when there is relative rotational movement between said driven shaft and said plurality of different diameter driven chain sprockets.

15. A drive train for a bicycle according to claim 14 wherein said body further comprises a finger that is biased to insert through an aperture of said driven shaft with said finger being received into a cavity of said selected single driven chain sprocket for engaging said selected single driven chain sprocket to said driven shaft when said aperture and said cavity are in alignment.

16. A drive train for a bicycle according to claim 15 wherein said finger is biased by a spring.

17. A drive train for a bicycle according to claim 15 wherein said body further comprises a plurality of fingers.

18. A drive train for a bicycle according to claim 17 wherein said plurality of fingers are biased by a plurality of springs.

19. A drive train for a bicycle according to claim 12 wherein said axial linkage is a direct acting control cable attached to a handlebar mounted selector on the bicycle wherein movement of said handlebar selector moves said direct acting cable resulting in axial movement of said body within said void.

20. A drive train for a bicycle according to claim 19 wherein said axial linkage further comprises a reverse acting control cable that is operable to move in an opposite direction from said directing acting control cable to axially pull said body axially bidirectionally within said void.
